(19) United States
(12) Patent Application Publication
(10) Pub. No.: US 2024/0194974 A1
(43) Pub. Date: Jun. 13, 2024

(54) HEAT MANAGEMENT DEVICE FOR AN ELECTRICAL AND/OR ELECTRONIC COMPONENT

(71) Applicant: VALEO SYSTEMES THERMIQUES, La Verriere (FR)

(72) Inventors: Cedric DE VAULX, La Verriere (FR); Kamel AZZOUZ, La Verriere (FR); Jeremy BLANDIN, La Verriere (FR); Yolanda BRAVO, La Verriere (FR)

(73) Assignee: VALEO SYSTEMES THERMIQUES, La Verriere (FR)

(21) Appl. No.: 18/554,063

(22) PCT Filed: Apr. 7, 2022
(86) PCT No.: PCT/EP2022/059195

§ 371 Date: Oct. 5, 2023

(30) Foreign Application Priority Data
Apr. 7, 2021 (FR) FR2103556

(51) Int. Cl. H01M 10/6557; H01M 10/625; H01M 10/643; H01M 10/6568

(52) U.S. Cl. CPC H01M 10/6557; H01M 10/625; H01M 10/643; H01M 10/6568

(57) ABSTRACT

The invention concerns a heat management device for at least one battery cell, including at least one rigid support part, a fluid recovery plate and a fluid distribution plate, the plates being arranged on either side of the rigid support part in a vertical direction of the rigid support part. The rigid support part includes at least one cavity for receiving the at least one battery cell and at least one channel formed parallel with the receiving cavity in the vertical direction and participating in forming a thermal regulation component.

### TECHNICAL FIELD

The present invention concerns a heat management device for an electrical and/or electronic component, for example a battery element suitable for use in an electrical storage device, in particular for a motor vehicle.

Electrical and/or electronic components of an electronic system to which the present invention can relate can also be components of computer servers and components of electrical energy storage systems, in particular batteries, for motor vehicles.

### BACKGROUND OF THE INVENTION

In the field of motor vehicles, electrical storage devices—otherwise known as batteries—can be used within vehicles in order to power various functions of said vehicles. The electrical storage devices normally used comprise at least one battery cell intended to store and/or deliver electrical energy. The operation of these electrical storage devices causes an increase in their temperature. In fact during operation, both when delivering electrical energy and when being recharged, the battery cell releases a large quantity of heat, the effect of which is to increase the temperature of the electrical storage device, which could in the long term damage and/or reduce the performance of the electrical storage device.

Thus to control the temperature of electrical storage devices at least during their operation, they can be associated with heat management devices. The heat management devices can for example reduce the temperature of the battery cell of the electrical storage device during its operation. In the case where the function of electrical storage devices is to supply a low-voltage network associated with electrical accessories of the vehicle, the cooling problems are simple to solve, in particular since said electrical storage devices have relatively small volumes.

However, in the case where electrical storage devices are used in the context of electrical or hybrid vehicles, in particular for their electric propulsion, said electrical storage devices have large volumes. Thus the problems of cooling these electrical storage devices for electric or hybrid cars are more difficult to solve.

### BRIEF SUMMARY OF THE INVENTION

The objective of the invention is to provide an alternative to the thermal regulation devices of electronic systems containing electrical and/or electronic components, whether these are computer servers, batteries of motor vehicles or any other type of electronic system having components which are liable to heat up during operation or while being charged, by proposing a thermal regulation device which is able to bring the electrical or electronic component to the desired temperature in a defined time. The aim is therefore to improve the performance of the heat management devices used to regulate the temperature of electronic systems, in particular when the latter have a large volume, for example for batteries used for propulsion of an electric or hybrid vehicle.

The invention therefore concerns a heat management device for at least one electrical and/or electronic component, comprising at least one rigid support part, a fluid recovery plate and a fluid distribution plate, said plates being arranged on either side of the rigid support part in a vertical direction of said rigid support part, the heat management device being characterized in that the rigid support part comprises at least one cavity for receiving the at least one electrical and/or electronic component and at least one channel formed parallel with the receiving cavity in the vertical direction and participating in forming a thermal regulation component.

The receiving cavities and channels formed in the rigid support part, each of which extends mainly in the vertical direction, are separate from one another such that the volumes they define respectively do not communicate with one another.

The function of the rigid support part is to form an intermediate piece between the thermal regulation component, formed at least partly by the channel, and the electrical and/or electronic component housed in the receiving cavity, so that the mutual relative positioning of the electrical and/or electronic components can be ensured and the heat and/or cold from the thermal regulation component can be transmitted by diffusion to each of the electrical and/or electronic components.

The heat management device can be used for an electronic system in the form of an electrical storage device, otherwise known as a battery, of a motor vehicle, with electrical and/or electronic components which take the form of battery cells. The function of the heat management device is then to regulate the temperature of the battery cell, for example by cooling it during operation or by preheating the battery on start-up.

According to a characteristic of the invention, the rigid support part is made of a material with high thermal conductivity. The rigid support part is made of a material with high thermal conductivity which can specifically act as a heat diffuser for the purpose of either heating or cooling the cells. A material with high thermal conductivity means that at 20° C., the thermal conductivity of the selected material is at least 120 W/m/K. In the case of a rigid support part produced with a composite of multiple materials, it can be understood that the thermal conductivity value should be considered as the mean of the thermal conductivity values of each material. In a non-limitative example of the invention, the material with high thermal conductivity comprises aluminum.

According to a characteristic of the invention, the receiving cavity and the channel of the rigid support part open on either side of said rigid support part in the vertical direction.

It is understood that the receiving cavity and the channel, which extend along a transverse direction of the rigid support part, are at each of their transverse ends in communication with an exterior environment of the rigid support part. As a non-limitative example, the rigid support part can be made by an extrusion process able to ensure the continuous nature of the receiving cavity and channel, the extrusion direction corresponding to the vertical direction along which the receiving cavity and channel extend.

According to a characteristic of the invention, the rigid support part comprises a plurality of channels in the rigid support part which are regularly distributed around the receiving cavity. The result of this arrangement, with the channels distributed regularly and extending over the entire vertical dimension of the cavity, is an even thermal regulation around the cavity and hence, by thermal diffusion via the material forming the rigid support part, an even thermal regulation of the electrical and/or electronic component housed in said cavity.

According to a characteristic of the invention, the fluid distribution plate comprises at least one over-thickness protruding from an inner face opposite the rigid support part and pierced by an opening, the fluid distribution plate being arranged against the rigid support part such that said opening is arranged at the level of the at least one receiving cavity of the rigid support part, and such that said over-thickness is in contact with the rigid support part between said receiving cavity and the channel.

More particularly, the contact between the rigid support part and the over-thickness is sealed. Such a sealed contact is advantageous in that it allows fluidic isolation of the receiving cavity when the channel which participates in forming the thermal regulation component receives a cooling fluid and/or a heating fluid.

The fluid can in particular comprise coolant, for example a mixture of water and glycol, or refrigerant, for example 1234YF or 134A. A heating fluid means a fluid intended to heat, which can comprise a coolant brought to a temperature greater than the temperature at instant T of the component to be thermally regulated.

According to a characteristic of the invention, the fluid distribution plate comprises a raised edge, the at least one over-thickness and the raised edge participating in delimiting at least one fluid circulation duct in fluidic communication with the at least one channel.

When the rigid support part comprises a plurality of channels, the circulation duct formed in the distribution plate is able to communicate with several of these channels such that the fluid circulating in the duct can be guided towards each channel intended to receive this specific fluid.

According to a characteristic of the invention, the over-thickness has a hexagonal cross-section with the opening arranged in the center.

In a configuration in which the fluid distribution plate comprises a plurality of over-thicknesses, each over-thickness is arranged at a distance not equal to zero from adjacent over-thicknesses, so as to form a passage for the fluid between the over-thicknesses and thus participate in forming the fluid circulation duct with the raised edge. In the context of over-thicknesses with a hexagonal cross-section, the fluid distribution plate and the fluid circulation duct have a honeycomb form.

According to a characteristic of the invention, the fluid distribution plate comprises a fluid inlet in fluidic communication with the fluid circulation duct.

It is understood that, in the case in which the thermal regulation component consists of a channel through which a cooling and/or heating fluid flows, this fluid is able to circulate from the fluid inlet of the distribution plate, and then in the circulation duct formed in the latter, in order to reach the at least one channel. Since the channel extends vertically in the rigid support part, the cooling and/or heating fluid flows in said channel parallel with the receiving cavity housing an electrical and/or electronic component, until it reaches the fluid recovery plate arranged opposite the fluid distribution plate in the vertical direction of the rigid support part.

According to a characteristic of the invention, the rigid support part comprises at least one outlet hole which is continuous in the vertical direction, the fluid distribution plate comprising at least one fluid outlet formed at the level of the outlet hole of the rigid support part.

The outlet hole opens on either side of the rigid support part in the vertical direction. It is understood that on one side, the outlet hole is level with the fluid outlet of the distribution plate, and on the other opens into the fluid recovery plate. Thus the outlet hole formed in the rigid support part and the fluid outlet are configured to evacuate the cooling and/or heating fluid from the heat management device. More precisely, once the cooling and/or heating fluid is collected by the fluid recovery plate, said cooling and/or heating fluid is able to circulate through the outlet hole and through the fluid outlet.

According to a characteristic of the invention, the fluid distribution plate comprises an additional thickness in which the fluid outlet is formed, level with the outlet hole of the rigid support part. The additional thickness then forms a protrusion on the inner face of the fluid distribution plate such that said additional thickness is in contact with the rigid support part. The contact between the additional thickness and the rigid support part can then be sealed such that said additional thickness fluidically isolates the outlet hole and the fluid outlet of the circulation duct.

According to a characteristic of the invention, the fluid recovery plate is tub-shaped, at least one closing plate being arranged between the rigid support plate and the fluid recovery plate, said closing plate being configured to form a wall closing the at least one receiving cavity and to comprise at least one perforation arranged opposite the at least one channel.

The tub-like shape of the recovery plate allows formation of a storage reservoir for cooling and/or heating fluid which circulates in the at least one channel up to the fluid recovery plate.

It is understood that the closing plate allows fluidic isolation of the receiving cavity from the cooling or heating fluid which flows into the recovery plate from the channel via the perforation arranged for this purpose in the closing plate. Secondly, the closing plate participates in holding at least one electrical and/or electronic component in the at least one receiving cavity of the rigid support part. In this way, the closing wall is configured to allow passage of the cooling and/or heating fluid from the channel to the recovery plate, and to seal the cavities housing the electrical and/or electronic components.

According to a characteristic of the invention, the closing plate comprises at least one fluid outlet cutout formed level with the fluid outlet hole of the rigid support part.

In this way, the cooling and/or heating fluid can circulate from the storage reservoir of the fluid recovery plate up to the outlet hole formed in the rigid support part.

According to a characteristic of the invention, at least one sealing sheet is arranged between the rigid support part and the one and/or the other of the fluid distribution plate and the fluid recovery plate, the sealing sheet being locally pierced to form orifices opposite each channel of the rigid support part.

According to an example of the invention, a first sealing sheet is arranged between the rigid support part and the fluid distribution plate, and a second sealing sheet is arranged between the rigid support part and the fluid recovery plate. The sealing sheets allow in particular an increase in tightness of the contact between the rigid support part and the corresponding plate, and thus an increase in the tightness of the least one receiving cavity housing the at least one electrical and/or electronic component, by preventing the cooling and/or heating fluid from reaching this cavity.

According to a characteristic of the invention, at least one sealed sheath extends into the channel of the rigid support part such that it separates said channel into two separate volumes which are sealed against one another.

In this context, each of the two separate volumes delimited by the channel of the rigid support part and the sealed sheath can participate in forming thermal regulation component which are separate from one another. Thus according to an example of the invention, within the same channel, the thermal regulation component can comprise a circulation volume for the cooling fluid and a resistive element in the volume delimited by the sheath. This optimises the volume of the channel and increases the adaptability of the heat management device by enabling it both to cool and heat the electrical and/or electronic component housed in the receiving cavity of the rigid support part.

In the same context, the channels which are regularly distributed around a receiving cavity can be arranged alternately, with channels comprising a sealed sheath and a resistive element within this alternating with channels with no sheath and through which a fluid, in particular a cooling fluid, passes.

According to a characteristic of the invention, the rigid support part comprises at least the channel on the periphery of the receiving cavity forming a first channel, and also comprises at least one second channel formed on the periphery of the receiving cavity and separate from the first channel, the second channel being fluidically isolated from the fluid circulation duct.

According to a characteristic of the invention, each of the first and second channels participates in forming one of the thermal regulation component of the rigid support part, the thermal regulation component being separate from one another.

Thus according to an example of the invention, the first channel can allow passage of the cooling fluid and the second channel can house a heating element, for example a resistive element. Such a characteristic is possible in particular because of the fluidic isolation between the first channel and the second channel, and also because of the fluidic isolation between the circulation duct and the second channel.

According to another example of the invention, the fluid distribution plate can comprise a first circulation duct and a second circulation duct which are separate from one another and in fluidic communication respectively with first channel and the second channel. This allows the circulation of cooling fluid in the first circulation duct and the first channel, and the circulation of heating fluid in the second circulation duct and the second channel.

According to a characteristic of the invention, at least one heat-conductive interface extends into the receiving cavity of the rigid support part, said heat-conductive interface being intended to be arranged between the rigid support part and the electrical and/or electronic component.

The function of the heat-conducting interface is in particular to limit the presence of air between the battery cell and the rigid support part at the level of the receiving cavity, and hence improve the exchange of heat between the rigid support part and the battery cell. The heat-conductive interface can then for example take the form of a flexible laminated graphite sheet ensuring contact between the battery cell and the rigid support part.

The invention also concerns an electronic system comprising at least one electrical and/or electronic component and a heat management device according to the preceding characteristics. This electronic system can in particular comprise a motor vehicle battery with electrical and/or electronic components taking the form of battery cells.

### BRIEF DESCRIPTION OF THE DRAWINGS

Further features, details and advantages of the invention will become more clearly apparent from reading the description given below by way of indication, with reference to the drawings, in which:

FIG. 1 is a general schematic view of an electronic system, here in the form of an electrical storage device, comprising at least one heat management device according to the invention;

FIG. 2 is a view of a first face of a rigid support part of the thermal management device from FIG. 1, showing a plurality of cavities for receiving an electrical and/or electronic component and a plurality of channels participating in forming a thermal regulation component;

FIG. 3 is a perspective view of a fluid distribution plate of the heat management device from FIG. 1;

FIG. 4 is an exploded view of part of the heat management device from FIG. 1, showing the rigid support part, the fluid distribution plate and a first sealing sheet;

FIG. 5 is an exploded view of part of the heat management device from FIG. 1, showing the rigid support part, a second sealing sheet, a closing plate and a fluid recovery plate; and

FIG. 6 is a schematic view of a channel of the rigid support part from FIG. 2 according to another exemplary embodiment, comprising at least one sheath and a resistive element.

### DETAILED DESCRIPTION OF THE INVENTION

It should first of all be noted that, while the figures set out the invention in detail for the implementation thereof, these figures can of course be used to better define the invention, where appropriate. It should also be noted that these figures set out only a number of examples of ways in which the invention can be embodied. Finally, the same reference signs designate the same elements in all figures.

The description below describes in more detail a heat management device for an electronic system in the form of a motor vehicle battery with electrical and/or electronic components in the form of battery cells. It should however be noted that the following description can apply to electronic systems of another type, such as computer servers for example.

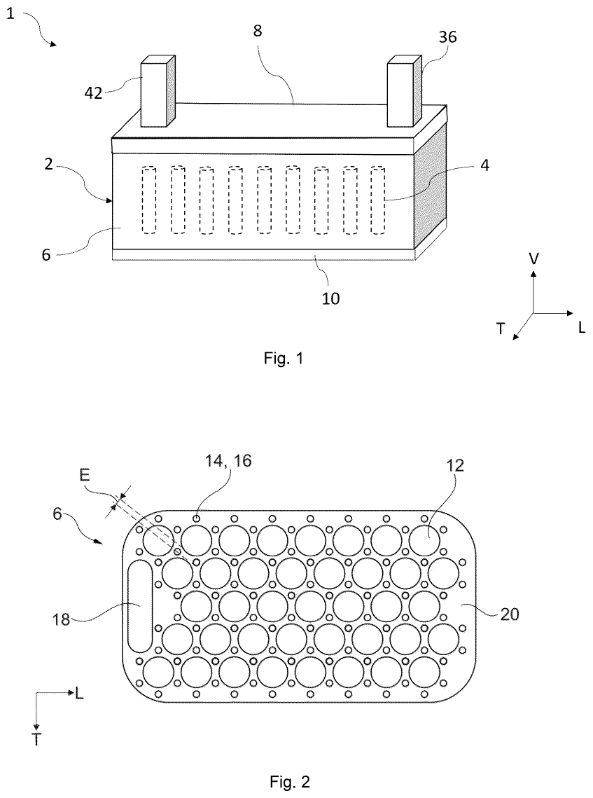

FIG. 1 illustrates an electrical storage device 1, otherwise known as a battery 1, for a vehicle. This electrical storage device 1 comprises at least one heat management device 2 according to the invention and at least one battery cell 4. In the illustrated example of the invention, the electrical storage device 1 comprises a plurality of battery cells 4. The function of the heat management device 2 is in particular to regulate the temperature of the battery cells 4, either during operation or on start-up of the vehicle. Depending on the configuration of the heat management device 2, this can either cool the battery cells 4 during operation of the electrical storage device 1, in order for example to avoid overheating phenomena which could in the long term damage the electrical storage device 1, and/or pre-heat the battery cells 4 before start-up of the vehicle. The heat management device 2 therefore allows optimization of use of the electrical storage device 1 by limiting its deterioration, and consequently that of the battery cells 4.

The heat management device 2 according to the invention comprises at least one rigid support part 6 designed to support the battery cells, and a fluid distribution plate 8 and a fluid recovery plate 10, wherein said plates 8, 10 are arranged on either side of the rigid support part 6 in the vertical direction V of the heat management device.

The rigid support part 6 will now be described in relation to FIG. 2. The rigid support part 6 comprises at least one receiving cavity 12, here a plurality of receiving cavities 12 each able to house one of the battery cells 4. Each of the receiving cavities 12 then forms a housing, here cylindrical with circular cross-section, in order to have a shape complementary to that of the battery cells 4 to be housed in the receiving cavity 12, the battery cells 4 here also being cylindrical. In the illustrated example of the invention, the main extent axis of the receiving cavities 12 is parallel with the vertical direction V of the rigid support part 6. More particularly, the plurality of receiving cavities 12 are open on either side of the rigid support part 6 along its vertical direction V, i.e. the receiving cavity 12 is open to the external environment of the rigid support part 6 in its vertical direction V.

In an example of the invention, the rigid support part can be made by an extrusion process allowing forming of the continuous receiving cavity, i.e. which opens on either side of said rigid support part.

As shown in FIG. 2, the rigid support part 6 comprises a plurality of receiving cavities 10 as defined above. In the example illustrated, the receiving cavities 10 are arranged so that they are aligned along at least two separate longitudinal straight lines, perpendicular to the vertical direction V of the rigid support part 6. It is understood that the rigid support part 6 thus comprises a plurality of receiving cavities 10 arranged in a matrix pattern. More particularly, in this example, the receiving cavities 10 aligned along one of the longitudinal straight lines are arranged offset to the receiving cavities 10 aligned along the other longitudinal straight line. The advantage of the mutually offset arrangement of the receiving cavities is that in this way, a sufficient thickness of the material of high thermal conductivity of the rigid support part can be retained to ensure the thermal regulation of the battery cells. In other words, a minimum mutual spacing E of the battery cells, measured between two adjacent battery cells, is defined, wherein the spacing E between two adjacent battery cells prevents the transfer of heat from one battery cell to the other.

The rigid support part 6 also comprises at least one channel 14 formed parallel with one of the receiving cavities 12 along the vertical direction V of said rigid support part 6, said channel 14 participating in forming a thermal regulation component 16. According to the illustrated example of the invention, the rigid support part 6 comprises a plurality of channels 14 formed parallel with the plurality of receiving cavities 12 for the battery cells 4, along the vertical direction V of the rigid support part 6. Thus each channel 14 of the plurality of channels 14 extends in the vertical direction V of the rigid support part 6, such that they open on either side of said rigid support part 6 in its vertical direction V. It is thus understood that each channel 14 of the rigid support part 6 is open to the external environment of said rigid support part 6 along its vertical direction V.

In particular, and as shown on FIG. 2, the plurality of channels 14 is configured such that several channels 14 are respectively arranged around a same receiving cavity 12, being regularly distributed around said cavity. The result of this arrangement, with the channels distributed regularly and extending over the entire vertical dimension of the cavity, is an even thermal regulation around the cavity and hence, by thermal diffusion via the material forming the rigid support part, an even thermal regulation of the battery cell housed in said cavity. In this arrangement, with the arrangement of the receiving cavities in a matrix pattern, one channel 14 can be common to two adjacent receiving cavities.

The rigid support part 6 also comprises at least one outlet passage hole 18 in the vertical direction V of the rigid support part 6. It is understood that the outlet hole 18 is vertically open at each end to the external environment of the rigid support part 6, and more particularly—as will be described in more detail below—onto the fluid distribution plate 8 and the fluid recovery plate 10. The outlet hole 18 is in particular formed on the periphery of the plurality of channels 14 and the plurality of receiving cavities 12, such that said outlet hole 18 is formed in the vicinity of a peripheral edge of the rigid support part 6.

In a non-limitative example of the invention, the rigid support part 6 can be made by an extrusion process so that the plurality of receiving cavities 12, the plurality of channels 14 and the outlet hole 18 can each extend continuously.

In the detailed description of the figures which follows, it is considered that the thermal regulation component 16 is formed by the channels 14 produced in the rigid support part 6 and by a cooling and/or heating fluid which circulates at least partly in said channels 14. The channels 14 thus participate in forming a thermal regulation component which is able to heat or cool the battery cell housed in the receiving cavity adjacent to the channels, depending on the type of fluid circulating in the channels. However, it should be noted that this exemplary embodiment of the invention, in which a cooling and/or heating fluid passes through each channel, is not limitative of the invention and a variant embodiment with resistive elements housed in at least some of the channels will be described below.

The rigid support part has a first face 20 and a second face 22 opposite one another in the vertical direction V of the rigid support part 6, i.e. the main extension direction of the cavities and channels. The fluid distribution plate 8 is then arranged against the first face 20 of the rigid support part 6, while the fluid recovery plate 10 is arranged against the second face 22 of the rigid support part 6. As stated, the outlet hole 18, each of the plurality of receiving cavities 12 and each channel 14 of the plurality of channels 14 are continuous and therefore open at the first face 20 and at the second face 22 of the rigid support part 6.

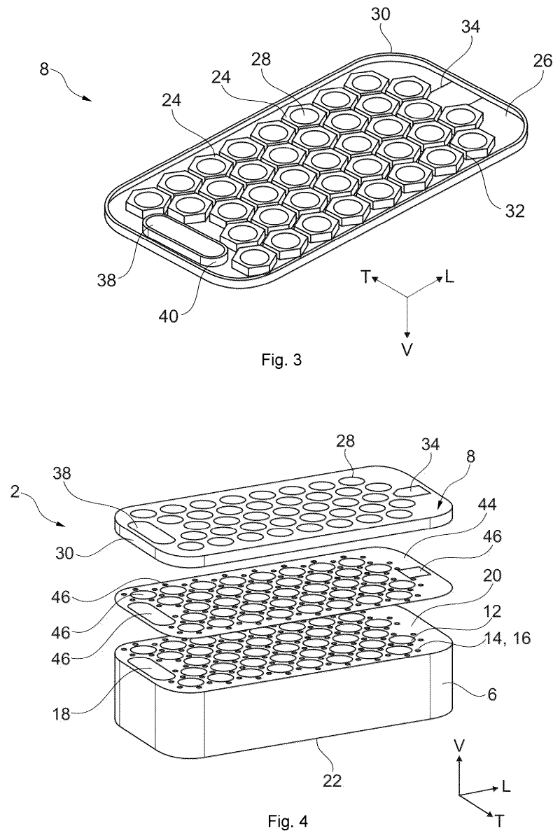

The fluid distribution plate 8 will now be described in more detail with reference to FIGS. 3 and 4. As shown in the example of the invention illustrated in FIG. 3, the fluid distribution plate 8 comprises at least one over-thickness 24 protruding from an inner face 26 of said fluid distribution plate 8. The inner face 26 of the fluid distribution plate 8 is the face intended to be positioned opposite the first face 20 of the rigid support part 6. In the example illustrated, the fluid distribution plate 8 comprises a plurality of over-thicknesses 24, each of hexagonal cross-section.

An opening 28 is formed in the center of each over-thickness 24 of the fluid distribution plate 8. When the fluid distribution plate is fixed to the rigid support part 6, for example by welding or brazing, these openings 28 formed in the over-thicknesses 24 of the fluid distribution plate 8 are each arranged level with one of the receiving cavities 12 of the rigid support part 6. In other words, each opening 28 extends in the axial continuity (here vertical) of a receiving cavity. In this way, once the fluid distribution plate is fixed to the rigid support part, it is possible to insert the corresponding battery cell in the receiving cavity by passing through the opening 28. Also, each of the over-thicknesses 24 of the fluid distribution plate 8 protrudes from the latter such that said over-thicknesses 24 are in contact with the first face 20 of the rigid support part 6 when the fluid distribution plate 8 is arranged against said first face 20. More precisely, each over-thickness 24 is in contact with the first face 20 of the rigid support part 6, at least between one of the receiving cavities 12 and one of the channels 14 formed on the periphery of said receiving cavity 12. In other words, the over-thicknesses allow a separation between the receiving cavity and the surrounding channels.

As shown on FIG. 3 in particular, the over-thicknesses 24 protrude from the inner face 26 of the fluid distribution plate 8, so as to form elements which are independent from one another and with a distance not equal to zero between each of the over-thicknesses 24. In this way, and as will be explained in detail below, the fluid is able to circulate between the over-thicknesses. When the fluid distribution plate is attached to the rigid support part 6, the spaces between the over-thicknesses are arranged opposite the channels, wherein each channel 14 opens onto a space arranged between the over-thicknesses and is thus not covered by an over-thickness. In other words, the fluid circulating between the over-thicknesses can flow in the channels, wherein the over-thicknesses form a rampart preventing the fluid from entering the receiving cavity surrounded by these channels.

According to a characteristic of the invention, the contact between each of the over-thicknesses 24 and the first face 20 of the rigid support part 6 is sealed. Such a characteristic is advantageous when the thermal regulation component 16 comprises at least the cooling and/or heating fluid flowing at least in the channels 14, wherein the receiving cavities 12 are fluidically isolated from said channels 14 and from a volume delimited by the fluid distribution plate 8. The circulation characteristics of the cooling and/or heating fluid will be explained in more detail below in the description which follows.

The fluid distribution plate 8 also comprises a raised edge 30 which extends on the periphery of said fluid distribution plate 8. The raised edge 30 and the plurality of over-thicknesses 24, spaced apart from one another by a distance not equal to zero, then participate in delimiting a circulation duct 32 for a fluid. It is clear from the above, and in particular from the particular shape of the over-thicknesses 24 of hexagonal cross-section, that the circulation duct 32 at least partly has a honeycomb form. The fluid circulating in the circulation duct 32 can then be the cooling and/or heating fluid which, by then flowing in the channels 14, participates in forming the above-mentioned thermal regulation component 16.

More precisely, the circulation duct 32 extends between the raised edge 30 and the plurality of over-thicknesses 24, and thus includes the spaces arranged between the over-thicknesses, such that the circulation duct is in fluidic communication with each channel 14 of the rigid support part 6.

The fluid distribution plate 8 also comprises a fluid inlet 34 formed such that it is in fluidic communication with the circulation duct 32. In particular, the fluid inlet 34 is formed by a hole in the fluid distribution plate, wherein no raised edge delimits said hole. It is understood that the fluid inlet 34 is in fluidic communication with the channels 14 of the rigid support part 6. According to the example of the invention in FIG. 1, a fluid inlet duct 36 can be arranged overlapping the fluid inlet 34 of the fluid distribution plate 8. Thus the fluid inlet duct 36 is able to distribute the cooling and/or heating fluid up to the circulation duct 32 and the channels 14 via the fluid inlet 34.

The fluid distribution plate 8 also comprises a fluid outlet 38, here arranged opposite the fluid inlet 34. This fluid outlet is formed on the distribution plate such that, when the latter is arranged against the first face 20 of said rigid support part 6, the fluid outlet 38 is arranged at the level of the outlet hole 18 of the rigid support part 6. More particularly, the fluid distribution plate 8 comprises an additional thickness 40 protruding from its inner face 26, the fluid outlet 38 being formed in said additional thickness 40. The additional thickness 40 is then formed such that it is in contact with the first face 20 of the rigid support part 6 when the fluid distribution plate 8 is arranged against said first face 20. More precisely, the additional thickness 40 of the fluid distribution plate 8 is in sealed contact with the first face 20 of the rigid support part 6.

Thus the additional thickness ensures the fluidic isolation of the outlet hole 18 and fluid outlet 38 relative to the circulation duct 32 formed on the fluid distribution plate 8. A fluid outlet duct 42 is arranged overlapping the fluid outlet 38, as illustrated in FIG. 1, so as to evacuate the cooling and/or heating fluid from the heat management device 2.

A first sealing sheet 44 can be arranged between the rigid support part 6 and the fluid distribution plate 8. The first sealing sheet 44 is then pierced such that it has a plurality of first orifices 46 formed level with the receiving cavities 12 and channels 14. These first orifices 46 have different dimensions depending on whether they are intended to face a receiving cavity 12 or a channel 14. It is understood that the first orifices facing the channels are designed not to obstruct the fluidic communication between the circulation duct 32 of the fluid distribution plate 8 and the channels 14 of the rigid support part 6, and that the first orifices facing the receiving cavities are designed not to obstruct the passage of battery cells when they are introduced into the receiving cavities 12.

One of the first orifices 46 of the first sealing sheet 44 can also be formed facing the fluid inlet 34 of the fluid distribution plate 8 so as not to obstruct the passage of fluid towards the circulation duct, and one of the first orifices 46 can also be formed opposite the outlet hole 18 of the rigid support part 6 and the fluid outlet 38 of the fluid distribution plate 8.

The first sealing sheet 44 participates in increasing the tightness between the fluid distribution plate 8 and the rigid support part 6, in particular at the level of the over-thicknesses 24 and the additional over-thickness 40 arranged in contact with the first face 20 the rigid support part 6, without said first sealing sheet 44 forming an obstacle in the above-mentioned fluidic communications.

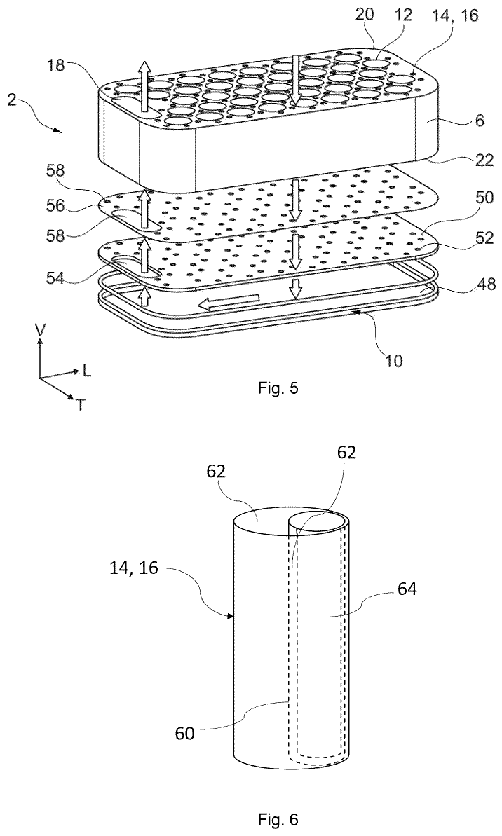

The heat management device 2 also comprises the fluid recovery plate 10 arranged against the second face 22 of the rigid support part 6, and particularly clearly shown on FIG. 5.

The fluid recovery plate 10 has a tub-like shape allowing delimitation of a storage reservoir 48 to collect the cooling and/or heating fluid circulating in the channels 14 of the rigid support part 6. The contact between the fluid recovery plate 10 and the rigid support part 6 is sealed during fixing of this plate and the support, in particular on their periphery, such that the cooling and/or heating fluid passing through the rigid support part via the channels remains contained in the storage reservoir 48 of said fluid recovery plate 10.

As shown on FIG. 5, a closing plate 50 is arranged between the rigid support part 6 and the fluid recovery plate 10.

The closing plate 50 is configured to allow closure of the receiving cavities 12 of the rigid support part 6 on its second face 22. It is understood that the closing plate 50 allows firstly participation in the sealing of the receiving cavities 12 against the storage reservoir 48 of the fluid recovery plate 10, and secondly participation in holding the battery cells within the receiving cavities 12 of the rigid support part 6.

Also, the closing plate 50 comprises at least one perforation 52 which is arranged in the vertical extension of one of the channels 14 of the rigid support part 6 when the heat management device 2 is assembled, this perforation allowing passage of the cooling and/or heating fluid from said channel 14 to the storage reservoir 48 of the fluid recovery plate 10. According to an example of the invention, the closing plate 50 comprises as many perforations 52 as the rigid support part 6 comprises channels 14, each perforation 52 being arranged at the level of one of said channels 14, i.e. in the vertical extension of the corresponding channel.

The closing plate 50 also comprises at least one fluid outlet cutout 54 formed level with the fluid outlet hole 18 of the rigid support part 6. Such a fluid outlet cutout 54 ensures fluidic communication between the storage reservoir 48 of the fluid recovery plate 10 and the outlet hole 18 of the rigid support part 6. In this way, the fluid which has been recovered in the storage reservoir, after passing through the rigid support part via the channels 14, can be directed to the outside of the heat management device via the outlet cutout and outlet hole 18.

A second sealing sheet 56 is arranged between the rigid support part 6 and the fluid recovery plate 10. More precisely, the second sealing sheet 56 is arranged between the closing plate 50 and the rigid support part 6. The second sealing sheet 56 is then locally pierced such that it has second orifices 58, each formed opposite at least one channel 14 of the rigid support part 6. According to the example illustrated in FIG. 5, the second sealing sheet 56 is pierced opposite each channel 14 of the rigid support part 6, such that when the heat management device 2 is assembled, each channel 14 is level with a second orifice 58 of the second sealing sheet 56. In this way, the second sealing sheet 56 allows fluidic communication between the channels 14 and the storage reservoir 48 of the fluid recovery plate 10.

Also, the second sealing sheet 56 is pierced opposite the outlet hole 18 of the rigid support part 6, such that the second orifice 58 opposite the outlet hole 18 allows fluidic communication between the storage reservoir 48 of the fluid recovery plate 10 and said outlet hole 18.

It is understood that the second sealing sheet 56 participates in guaranteeing the tightness between the closing plate 50 and the second face 22 of the rigid support part 6 by increasing the fluidic isolation of the receiving cavities 12 at the level of the second face 22 of the rigid support part 6, while allowing the passage of cooling and/or heating fluid from the channels through said second sealing sheet 56.

The circulation of cooling and/or heating fluid within the heat management device 2 will now be described in more detail in relation to FIGS. 1 to 5, with reference to an example in which the heat management device 2 according to the invention comprises a thermal regulation component 16 consisting of channels and a cooling fluid and/or a heating fluid circulating in said channels.

The fluid intended to provide the appropriate thermal regulation, namely a cooling fluid when the temperature of the battery cells must be lowered or a heating fluid when the battery cells must be preheated, is conducted into the heat management device 2 by means of the fluid inlet duct 36. More precisely, the cooling and/or heating fluid circulates in the fluid inlet duct 36 then passes through the fluid inlet 34 of the fluid distribution plate 8 to reach the circulation duct 32.

Once the fluid is present in the circulation duct 32 formed between the inner face 26 of the fluid distribution plate 8 and the rigid support part, this fluid can flow between the over-thicknesses 24 over the entire extent of the fluid distribution plate. In this context, the circulation duct 32 allows the distribution of fluid in each channel 14 of the rigid support part 6 which opens into said circulation duct at the level of the first face 20. The cooling and/or heating fluid then passes through the rigid support part 6 by flowing vertically along channels 14 parallel with the receiving cavity 12. The temperature difference between the cooling fluid circulating in a channel 14 and the hot battery cell present in the receiving cavity generates an exchange of heat through the material of the rigid support part 6, and the cooling fluid recovers heat as it is conducted towards the fluid recovery plate 10. Similarly, the temperature difference between the heating fluid circulating in a channel 14 and the still cold battery cell present in the receiving cavity generates an exchange of heat through the material of the rigid support part 6, and the heating fluid delivers heat as it is conducted towards the fluid recovery plate 10.

As has been described above, it is advantageous that the channels 14 are thus distributed regularly around a receiving cavity and over the entire vertical dimension of said cavity, such that the recovery or delivery of heat takes place evenly over the entire extent of the battery cell present in the receiving cavity.

In other words, the circulation of the cooling and/or heating fluid in the channels 14 respectively allows cooling and/or heating of the battery cells 4 housed in the receiving cavities 12 of the rigid support part 6 by diffusion, through the material of the rigid support part, of the heat and/or cold generated by the thermal regulation component 16, here the cooling and/or heating fluid which flows in the channels 14. In order to optimize the heat exchange and the heating or cooling of the battery cells, depending on the type of fluid circulating in the channels, the rigid support part 6 can be made of a material with high thermal conductivity. A material with high thermal conductivity means that at 20° C., the thermal conductivity of the selected material of high thermal conductivity is at least 120 W/m/K.

The fluid then flows into the storage reservoir 48 of the fluid recovery plate 10 by passing through at least the perforations 52 of the closing plate 50. Once collected in the storage reservoir 48 of the fluid recovery plate 10, the cooling and/or heating fluid is drawn through the fluid outlet cutout 54 of the closing plate 50 into the outlet hole 18 of the rigid support part 6 via the fluid outlet duct 42 arranged overlapping the fluid outlet 38 of the fluid distribution plate 8. The cooling and/or heating fluid is then evacuated outside the heat management device 2.

Another embodiment of the invention will now be described with reference in particular to the illustration in FIG. 6. The heat management device in this case differs from that just described in that the heating function of the battery cells, previously performed by the passage of heating fluid through the channels 14, is here achieved by the presence and electrical supply of resistive elements present in all or some of the channels 14. In this context, it is no longer necessary to provide a heating fluid but simply a cooling fluid, which can have the merit of simplifying installation of the fluid supply upstream and downstream of the heat management device.

As illustrated on FIG. 6, a sheath 60 extends into at least one channel 14 of the rigid support part such that said sheath 60 separates said channel 14 into two separate volumes 62 which are sealed against one another. The sheath 60 forms a sealed envelope for a resistive element 64 such that said resistive element is not in contact with the inner volume of the corresponding channel.

According to a first variant of this embodiment, each of the two separate volumes 62 formed in the one of the channels 14 participates in forming a thermal regulation component 16 with the resistive element inside the sheath (which in some cases is powered to form a thermal regulation component able to heat the battery cell in the adjacent receiving cavity), and with the volume 62 of the channel 14, separate from the sheath 60, which fluidically communicates with the fluid circulation duct 32 which this time is supplied exclusively with cooling fluid.

According to a second variant of this embodiment, no fluid is intended to circulate in the channels 14 containing a sheath 60, wherein the ends of the channels 14 opening onto the first face 20 are covered to prevent fluidic communication with the circulation duct. These channels contain a sheath, the sole function of which is to form a thermal regulation component able to heat the adjacent battery cell. In this variant, it is suitable to alternate the arrangement of channels around a same receiving cavity, with alternate channels comprising a sheath and a resistive element and channels without sheath and intended to conduct the cooling fluid.

In each variant, the resistive element within the sheath has a connection end which runs between the first face and the fluid distribution plate up to a sealed electrical connector allowing electrical supply to the resistive element. The connecting end is isolated from the fluids liable to circulate in the circulation duct by an extension of the sheath 60 into this circulation duct.

This embodiment of the invention is advantageous in that it allows optimization of the volume of the channels 14 by allowing the latter to contain battery cell heating component and battery cell cooling component, while simplifying the hydraulic architecture associated with the heat management device since it is limited to managing a single fluid.

Other variants (not shown here) can be implemented without leaving the scope of the invention. As a non-limiting example, the heat management device can comprise a plurality of heat-conductive interfaces each arranged in one of the receiving cavities of the rigid support part, such that a conductive interface is arranged between the rigid support part and a battery cell. The function of the heat-conductive interface is then to facilitate contact transmission of the heat and/or cold between the rigid support part and the battery cell, in particular by limiting the air present between these two parts, the presence of air having the effect of thermally isolating the battery cell.

The heat-conductive interface can comprise a resistive element, for example a nickel sheet, connected to an electrical supply. In this way, the heat-conducting interface is able to transmit heat to the battery cell, wherein said resistive element housed in the conductive interface forms the first thermal regulation component.

According to another variant example, the fluid distribution plate can be configured to form two separate circulation ducts. In this context, a first circulation duct and a second circulation duct can be defined, which respectively conduct a cooling fluid and a heating fluid. The heat management device is then distinguished in that the channels formed in the rigid support part are divided into first channels and second channels, which each communicate exclusively with the first circulation duct and the second circulation duct respectively. Depending on the fluid conducted towards the heat management device, thus the heat management device can be used both for cooling the battery cells and also for heating said battery cells.

The advantage of the invention as just described is that it allows, by means which are simple to implement and hence low-cost, an improvement in the thermal regulation of at least one electrical and/or electronic component, for example a battery cell.

The invention is not however limited exclusively to the embodiments and exemplary methods described and illustrated, and also applies to all means or configurations, and to any combination of such means or configurations, which allow an equivalent improvement in the thermal regulation of at least one electrical and/or electronic component when a combination of a thermal regulation component and a rigid part forming a support for said electrical and/or electronic component is used.

What is claimed is:

1. A heat management device for at least one electrical and/or electronic component, comprising at least one rigid support part, a fluid recovery plate and a fluid distribution plate, with the fluid recovery plate and the fluid distribution plates being arranged on either side of the at least one rigid support part in a vertical direction of said at least one rigid support part, wherein the at least one rigid support part includes at least one receiving cavity for receiving the at least one electrical and/or electronic component and at least one channel formed parallel with the at least one receiving cavity in the vertical direction and participating in forming a thermal regulation component.

2. The heat management device as claimed in claim 1, wherein the at least one receiving cavity and the at least one channel of the at least one rigid support part open on either side of said at least one rigid support part in the vertical direction.

3. The heat management device as claimed in claim 1, wherein the at least one rigid support part includes a plurality of channels formed in the at least one rigid support part and distributed regularly around the at least one receiving cavity.

4. The heat management device as claimed in claim 1, wherein the fluid distribution plate includes at least one over-thickness protruding from an inner face opposite the at least one rigid support part and pierced by an opening, the fluid distribution plate being arranged against the at least one rigid support part such that said opening is arranged at the level of the at least one receiving cavity of the at least one rigid support part and such that said at least one over-thickness is in contact with the at least one rigid support part between said at least one receiving cavity and the at least one channel.

5. The heat management device as claimed in claim 4, wherein the fluid distribution plate includes a raised edge, the at least one over-thickness and the raised edge participating in delimiting at least one fluid circulation duct in fluidic communication with the at least one channel.

6. The heat management device as claimed in claim 5, wherein the fluid distribution plate includes a fluid inlet in fluidic communication with the at least one fluid circulation duct.

7. The heat management device as claimed in claim 1, wherein the fluid recovery plate is tub-shaped, at least one closing plate being arranged between the rigid support plate and the fluid recovery plate, said at least one closing plate being configured to form a wall closing the at least one receiving cavity and to include at least one perforation arranged opposite the at least one channel.

8. The heat management device as claimed in claim 1, wherein at least one sealing sheet is arranged between the at least one rigid support part and the one and the other of the fluid distribution plate and the fluid recovery plate, the at least one sealing sheet being locally pierced to form orifices opposite the at least one channel.

9. The heat management device as claimed in claim 1, wherein at least one sealed sheath extends into the at least one channel of the at least one rigid support part such that it separates said at least one channel into two separate volumes which are sealed against one another.

10. An electronic system of a vehicle, comprising a heat management device for at least one electrical and/or electronic component, including at least one rigid support part, a fluid recovery plate and a fluid distribution plate, with the fluid recovery plate and the fluid distribution plates being arranged on either side of the at least one rigid support part in a vertical direction of said at least one rigid support part, wherein the at least one rigid support part includes at least one receiving cavity for receiving the at least one electrical and/or electronic component and at least one channel formed parallel with the at least one receiving cavity in the vertical direction and participating in forming a thermal regulation component, the electronic system of a vehicle further comprising at least one electrical and/or electronic component mounted in the at least one receiving cavity of a heat management device.

11. The heat management device as claimed in claim 1, wherein at least one sealing sheet is arranged between the at least one rigid support part and the one or the other of the fluid distribution plate and the fluid recovery plate, the at least one sealing sheet being locally pierced to form orifices opposite the at least one channel.
